(19) United States
(12) Patent Application Publication
(10) Pub. No.: US 2026/0132938 A1
(43) Pub. Date: May 14, 2026

(54) Heating Device for an Air Treatment Unit, and Air Treatment Unit

(71) Applicant: KNORR-BREMSE Systeme fuer Nutzfahrzeuge GmbH, Muenchen (DE)

(72) Inventors: Karsten SCHNITTGER, Muenchen (DE); Thomas ERTL, Muenchen (DE)

(21) Appl. No.: 19/118,424

(22) PCT Filed: Sep. 28, 2023
(86) PCT No.: PCT/EP2023/076899

§ 371 Date: Apr. 4, 2025

(30) Foreign Application Priority Data
Oct. 6, 2022 (DE) 10 2022 125 830.0

(51) Int. Cl. F24F 1/0373

(52) U.S. Cl. CPC F24F 1/0373

(57) ABSTRACT

A heating device is provided for an air treatment unit with at least one first assembly and a second assembly, wherein the first assembly has at least one receiving element and the second assembly has at least one fixing element. The receiving element and the fixing element are designed such that the receiving element and the fixing element can be connected with respect to one another in a predefined orientation region, in particular in a predefined angular region.

### BACKGROUND AND SUMMARY

The present invention relates to a heating device for an air treatment unit, having at least one first assembly and one second assembly. Furthermore, the invention relates to an air treatment unit having such a heating device.

In systems for air treatment there is usually a drainage valve by way of which humid air and water condensation can be ejected.

In order to prevent freezing of this drainage valve at low temperatures, an electrically operated heating is typically placed close to the valve. When the heating is energized, the heating member is heated and thus also the region of the housing about the drainage valve.

In most instances, two different versions of such air treatment systems are used, wherein in a first variant the air dryer unit is not fastened to the core module or main module, and the air dryer unit has an external heating which is supplied with power by way of a cable. In a second variant, the air dryer unit can be fastened to the core module or main module, wherein the heating is accommodated in the air dryer unit and is supplied with power by the control unit (ECU) of the core module.

In this second variant, parts of the heating component have to be accommodated across boundaries of modules, in the air dryer unit having the drainage valve as well as in the core module having the control unit.

In order to avoid damage to the heating component when transporting the modules of the air treatment system, it is expedient to split the heating component into at least two (sub-)assemblies which are accommodated in the respective module of the air treatment installation and project at most slightly or to a minor extent, or protrude from the respective module.

Moreover, the heating assemblies must not fall out of the respective module during the assembly process. Furthermore, the interface between the heating assemblies has to be protected against splash water so as to be able to preclude electrical short-circuits, corrosion and/or the like.

It is the object of the present invention to refine a heating device of the type mentioned at the outset in an advantageous way, in particular with the view to permitting simple, cost-effective and reliable assembly, wherein assembling out of position is to be prevented, and automated assembly is preferably to be enabled, so that a safe and resilient heating device is able to be provided. It is furthermore an object of the invention to specify an air treatment system having such a heating device.

This object is achieved by a heating device and by an air treatment system in accordance with the independent claim(s).

Accordingly, it is provided that a heating device for an air treatment unit is designed having at least one first assembly and one second assembly, wherein the first assembly has at least one receptacle element, and the second assembly has at least one fixing element. The at least one receptacle element and the at least one fixing element are designed to engage in one another so as to at least temporarily connect the first assembly and the second assembly to one another, wherein the receptacle element and the fixing element are designed in such a manner, preferably are designed having an orientation element in such a manner, that the receptacle element and the fixing element are able to be connected in a predefined alignment range, in particular a predefined angular range, relative to one another.

The invention is based on the basic concept that a heating device consisting of a plurality of assemblies can be provided in a compact construction mode, and in particular so as to be integrated into an air treatment unit.

The at least two assemblies of the heating device can be connected to one another, or linked to one another, in order to provide an electrical connection.

In this way, the air treatment unit to which the heating device is assigned can be divided into a plurality of modules and designed in a compact manner.

Furthermore, assembling of the air treatment unit, preferably in the form of an air dryer unit, can be automated, wherein the first assembly is placed and screwed for example into an air treatment module, and the second assembly of the heating device is placed and screwed for example into a core module or main module of the air treatment unit. The electrical contacting of the heating device can be performed by a reliable process by means of the present invention.

A specific geometric design embodiment of at least one of the two assemblies makes it possible that the two assemblies are able to be connected to one another only in a specific alignment relative to one another, or in a predefined alignment/angular range.

The two heating assemblies, in terms of the angular position of the plug connection and in terms of their radial position, have to be aligned in such a way that the plug connection can always reliably establish an electrical contact. The component tolerances and the tolerances of the devices for the joining process during assembly can be taken into account here so that a preliminary positioning can be performed, and the individual elements of the heating device are furthermore designed so as to compensate radial offsets relative to one another.

According to a preferred embodiment, the first assembly and/or the second assembly are/is designed to be at least partially elastically deformable, in particular the receptacle element and/or the fixing element are/is at least partially elastically deformable.

In particular, the receptacle element and/or the fixing element can have an at least partially elastically deformable material.

Alternatively or additionally, a partially elastic deforming capability can be provided, for example, by a corresponding geometric design embodiment of the receptacle element and/or of the fixing element.

According to one embodiment, the fixing element and/or the receptacle element have/has a chamfer portion so that preliminary positioning of the receptacle element and of the fixing element relative to one another is able to be provided before a mutual engagement is formed by the receptacle element and the fixing element for connecting the first and the second assembly.

According to one embodiment, it is provided that the preliminary positioning of the receptacle element and of the fixing element enables a mutual radial displacement to be compensated.

In particular, it can be provided by means of at least one such chamfer portion that the fixing element and the receptacle element can slide relative to one another so as to compensate any radial offset, or an offset in the radial direction.

A radial offset can be compensated or corrected in this way when joining the first and the second assembly. In this way, a simple and reliable mutual engagement of the receptacle element and the fixing element can be guaranteed for a force-fitting and/or form-fitting linking, and preferably for establishing an electrical contact or the like.

According to a further embodiment, the first assembly is designed having at least one first line component, and the second assembly is designed having at least one second line component, for forming an electrical connection, wherein an electrical contact between the first and the second assembly is able to be established once the preliminary positioning of the first assembly and of the second assembly relative to one another has been at least substantially performed.

In particular, an energy supply of the heating device by way of the control unit of an air treatment unit can be able to be provided along the first and the second line components to be connected to one another.

In a preferred embodiment, at least the first line component and the second line component are designed to form a mutual plug connection.

In this context, the first and the second line component can be provided as electrically conducting pins, for example, so that a plug connection by means of the receptacle element and of the fixing element can establish a reliable electrical connection along the first and the second line components.

According to a further embodiment, the first and/or the second line component has a chamfer portion or the like, so that a radial offset between the first and the second line component is able to be compensated.

According to one embodiment, the first and/or the second line component is at least partially flexibly deformable, so that a radial offset between the first and the second line component is able to be compensated.

By means of the chamfer portions and the at least partially elastic deformation capability, an offset of the line components in the radial direction can also be compensated in order to be able to provide secure and reliable joining for establishing an electrical connection, for example in the context of an automated assembly or production process.

According to a preferred embodiment, the first assembly and/or the second assembly has at least one sealing element for sealing, in particular for sealing in a liquid-tight manner, the at least temporary connection between the first assembly and the second assembly.

The multi-part heating device can be protected in relation to the ingress of water and against electrical short circuits, corrosion and the like during use, i.e., in the joined or assembled state.

In particular, the sealing element can be provided as an annular seal or O-ring, as a sealing mat, or the like.

According to a further preferred embodiment, the first assembly and/or the second assembly are/is designed in such a manner that the at least one sealing element is able to be captively positioned on the first assembly and/or the second assembly.

In this way, the sealing element is securely positioned also during the process for joining the assemblies of the heating device, so that a sealing function is guaranteed in the joined state.

According to a further embodiment, at least one of the first and the second assembly has a fastening element for captively disposing the first and/or the second assembly in an air treatment unit, preferably in a first module and/or a second module of the air treatment unit, and in particular in an assembled state of the air treatment unit.

It can be ensured in this way that the first and/or the second assembly are/is securely positioned or disposed preferably before, during and after joining the heating device, or the associated air treatment unit.

It can be provided in particular that the receptacle element is securely or captively positioned on the first assembly of the heating device and/or the first module of the air treatment unit by means of at least one fastening element, and/or the fixing element is securely or captively positioned on the second assembly of the heating device and/or the second module of the air treatment unit by means of at least one fastening element.

In the context of the present invention, an air treatment unit for use with the heating device according to the invention can be provided in particular in such a manner that the first and/or the second module (each) can be designed for mutually engaging with the first and/or the second assembly of the heating device, in particular be designed with in each case at least one fastening element.

The first and/or the second assembly of the heating device can be captively disposed or positioned, in particular within an associated (assembled) air treatment unit.

According to a coordinated aspect of the present invention, an air treatment unit, in particular an air dryer unit, having a heating device according to the invention is provided. According to a preferred embodiment, the air treatment unit is provided with at least one first module and at least one second module, wherein the first module has the first assembly of the heating device, and the second module has the second assembly of the heating device.

Accordingly, the heating device can advantageously be designed in two parts, or multiple parts, and be disposed efficiently in terms of installation space.

According to one embodiment, the first module is an air dryer module or a core module of the air treatment unit, and the second module is a core module or main module, or an air dryer module, of the air treatment unit.

According to a preferred embodiment, the heating device is provided so as to be integrated in the air treatment unit, in particular in an assembled state of the heating device.

The first heating assembly, having a heating cartridge for generating heat, can preferably be accommodated in the air dryer module and comprise part of an electrical plug connection, in particular heating pins. The second heating assembly for the electrical connection to the control unit can be accommodated in the core module or main module, and likewise have part of an electrical plug connection, in particular sleeves, on the connecting pins.

A disposal of the heating device within an air treatment unit which is efficient in terms of installation space and can be joined in a simple and reliable manner, in particular also in the context of an automated process, is made available.

The present invention will be explained in more detail hereunder with reference to the appended figures.

### BRIEF DESCRIPTION OF THE DRAWINGS

FIG. 1 shows a perspective illustration and a perspective sectional illustration of a first assembly of a heating device according to a first exemplary embodiment;

FIG. 2 shows a perspective illustration of a second assembly of a heating device according to a first exemplary embodiment;

FIG. 3 shows a sectional illustration of the first and the second assemblies according to FIGS. 1 and 2, in the assembled state; and

FIG. 4 shows a sectional illustration of the various method steps for assembling the first and the second assembly according to FIGS. 1 to 3.

### DETAILED DESCRIPTION OF THE DRAWINGS

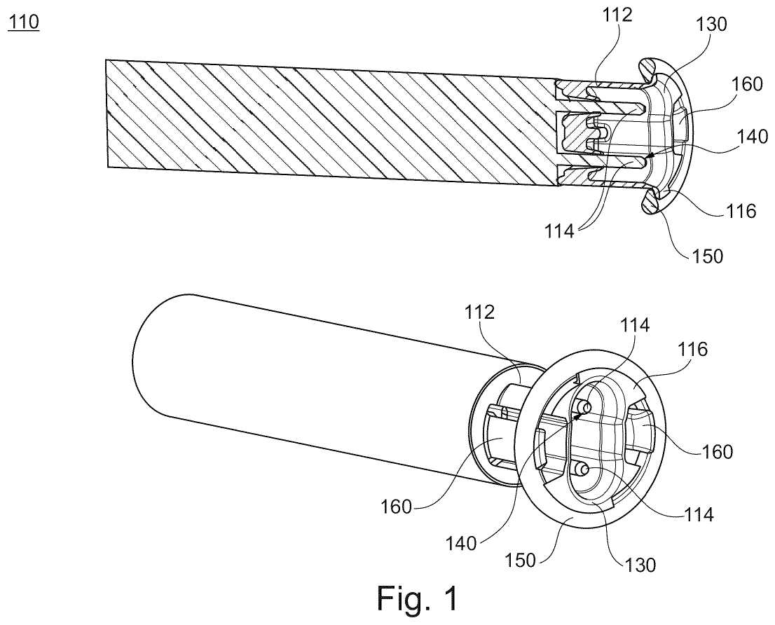

FIG. 1 shows a perspective illustration and a perspective sectional illustration of a first assembly 110 of a heating device 100 according to a first exemplary embodiment.

According to FIG. 1, the first assembly is designed having a receptacle element 112 and a first line component 114.

The first line components 114 shown according to FIG. 1 are provided as electrical (contact) pins.

The first line components 114 can in each case have chamfer portions 114 on their tips.

The first line components 114 are surrounded by the receptacle element 112, or disposed in the receptacle element 112.

The receptacle element 112 forms in particular a concavity in the context of a female joining structure, for receiving a corresponding mating part such as, for example, a fixing element in the context of a male joining structure.

The receptacle element 112 is designed having a chamfer portion 130 on its end side, in particular having an internal and substantially encircling chamfer portion 130, so as to simplify joining to a corresponding mating part, preferably a fixing element.

The receptacle element 112 has at least one fastening element 160.

The fastening element 160 in the context of a circumferential direction can be directed outwards so as to enable an engagement in a housing or the like, for fastening or linking to or along the first assembly 110.

Furthermore, the receptacle element 112 can have at least one orientation element 116, for example in the form of a projecting or protruding cone, so that the first assembly 110 is able to be connected to a corresponding second assembly only in a specific angular range.

It is possible that the first assembly 110, or the receptacle element 112, has a plurality of identical or dissimilar orientation elements 116, so that connecting to the first assembly is possible only in one direction, or in a specific angular range. In this context, the at least one orientation element allows a connection to the first assembly according to the key-and-lock principle.

The geometry, for example an external contour, of the receptacle element 112 and/or of the fixing element 122 can be designed in such a manner that the first and the second assembly 110; 120 are able to be connected only when positioned relative to one another in a specific alignment or angular range.

The fastening element 160 can preferably be designed to be at least partially elastic, so as to enable releasable linking in the context of a force-fitting and/or form-fitting connection for providing a captive protection along the first assembly 110, or along a first module 210, respectively.

According to FIG. 1, the first assembly 110 can have a sealing element 150, preferably in the form of an annular seal or an O-ring or the like.

The sealing element 150 can be disposed along an external circumference of the first assembly and rest on the at least one fastening element 160, for example.

Moreover, the receptacle element 112 can be designed to be at least partially elastically deformable, in particular have an at least partially elastically deformable material.

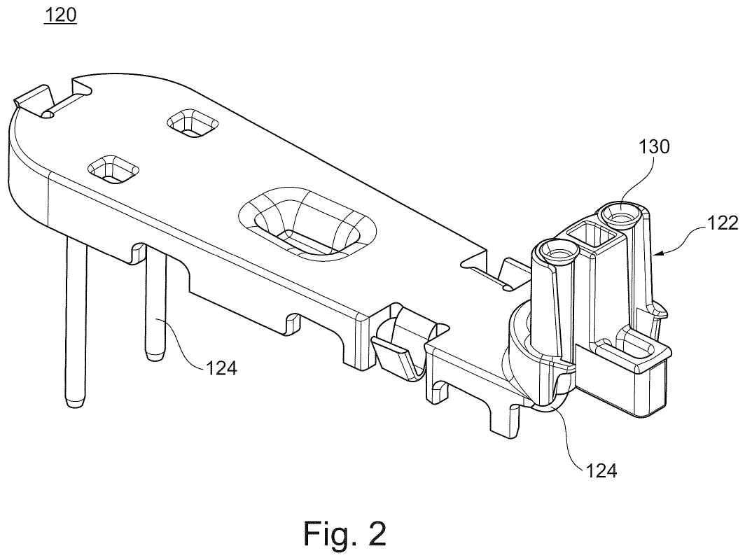

FIG. 2 shows a perspective illustration of a second assembly 120 of a heating device 100 according to a first exemplary embodiment.

The second assembly 120 can in particular be designed having a fixing element 122, preferably in the context of a male joining structure.

The fixing element 122 can be designed in one part or in multiple parts. According to FIG. 2, the fixing element of the second assembly 122 is provided with additional sleeve inserts, in particular for receiving first and second line components 114; 124, respectively.

According to FIG. 2, the at least one second line component 124 extends along the second assembly 120 and is disposed or received within the fixing element 122.

The fixing element 122 is designed having a chamfer portion 130, in particular so that an introduction of first line components 114, preferably in the form of (connecting) pins, can be enabled.

The fixing element 122 having the chamfer portion 130 can thus serve to fasten the second assembly, the connection of the second line component 124 to the first line component 114 within the fixing element 122 being advantageously enabled.

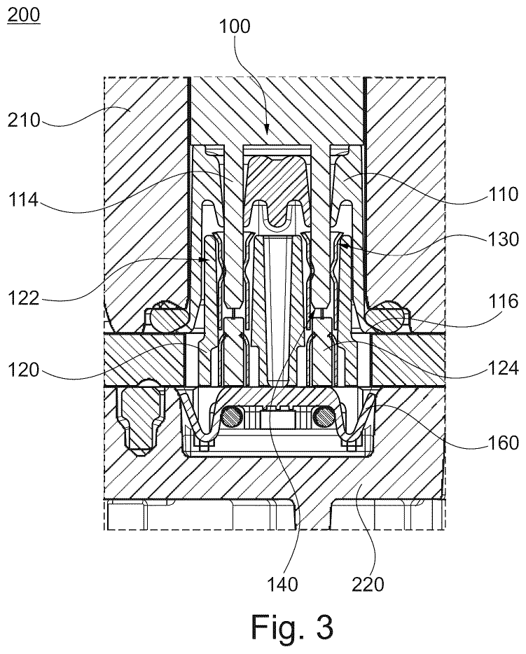

FIG. 3 shows a sectional illustration of the first and the second assemblies 110; 120 of a heating device 100 according to FIGS. 1 and 2, in the assembled or joined state. In particular, the heating device 100 can be provided as part of an air treatment unit 200, for example of an air dryer unit.

The first assembly 110 can be provided or disposed in a first module 210 for example. The first module 210 can be, for example, an air dryer module or a main module or core module.

According to FIG. 3, the second assembly 120 can be provided or disposed in a second module 220. The second module 220 can be, for example, a main module or core module, or an air dryer module, in particular so as to correspond to the first module 210.

The heating device 100, by way of a control unit of the main module or core module, can be supplied with power along the first and second line components 114; 124 to be electrically connected to one another.

It is provided in particular according to FIG. 3 that the sealing element 150 in the assembled state of the air treatment unit 200, or of the heating device 100, can be compressed on or between the first and/or the second module 210; 220, in particular in such a way that a fluid-tight connection can be provided along the interface between the first and the second module 210; 220.

It can furthermore be seen from FIG. 3 that the fixing element 122 of the second assembly 120 is received in the receptacle element 112 of the first assembly 110 of the heating device 100, so that electrical contacting is able to be provided between the first and the second line components 114; 124.

In particular, the first and the second line components can be mutually aligned and guided in the receptacle element 122 in such a manner that secure and reliable electrical contacting is possible.

In the assembled state of the heating device 100 the receptacle element 112 and the corresponding fixing element 122 engage in one another so as to be able to establish an electrical connection by way of the first and the second line components 114; 124.

The fastening elements 160 of the first assembly 110 and/or of the second assembly 120 of the heating device 100 can provide a captive protection, in particular before, during and after assembling the first and the second assembly 110; 120. In this context, the first and the second assembly 110; 120 can be held in the first and the second module 210; 220, respectively, in such a way that assembling or constructing the heating device is facilitated.

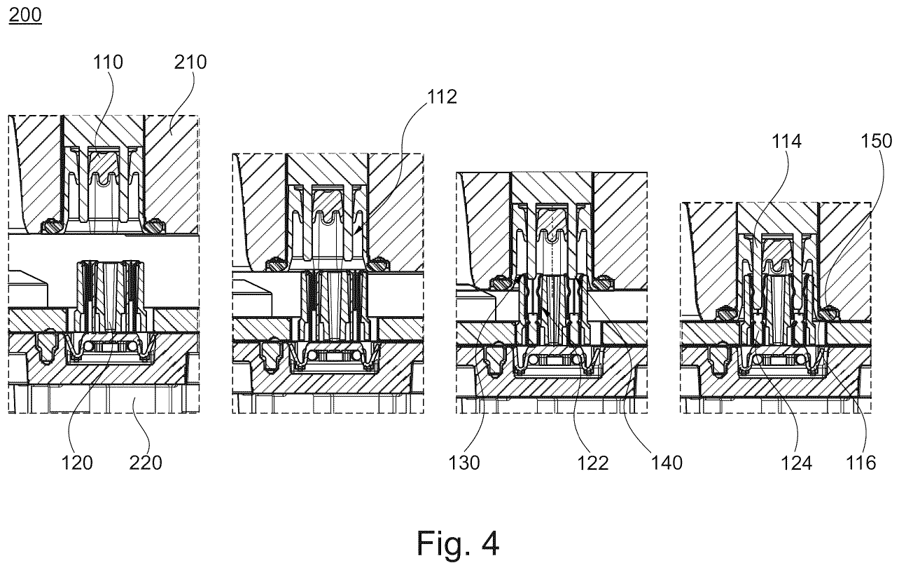

FIG. 4 shows a sectional illustration of the various method steps for assembling the first and the second assembly 110; 120 of the heating device 100 according to FIGS. 1 to 3.

In one step, the first assembly 110 and the second assembly 120, or the first and the second module 210; 220, are roughly aligned with one another.

As soon as a first contact is established between the receptacle element 112 and the fixing element 122, the fixing element and the receptacle element can slide along the chamfer portions 130 relative to one another in such a manner that a preliminary positioning can be performed for compensating an offset in the radial direction.

Likewise, the first line components of the first assembly can have a chamfer portion 140, so that sliding in relation to the chamfer portions of the fixing element 122 can be performed.

The fixing element 122 and the receptacle element 112 can in particular be at least partially elastically deformable in order to facilitate the joining procedure and the mutual alignment.

As soon as the first line components 114 are received in, or introduced into, the fixing element 122, a compression of the sealing element 150 can take place by joining the first and the second module 210; 220, so that a fluid-tight interface can be provided.

In summary, the present invention provides a simple and secure possibility for connecting two assemblies 110; 120 of a heating device 100.

A correct alignment or positioning of the assemblies 110; 120 relative to one another can be ensured by means of a geometric design embodiment of the assemblies 110; 120, for example by means of orientation elements 116.

The formation of chamfer portions 130; 140 enables relative radial offsets of the assemblies to be compensated, so that secure joining of the assemblies 110; 120 is guaranteed in order to enable an electrical connection along the line components 114; 124.

The assemblies 110; 120, in particular the receptacle element 112 and/or the fixing element 122, herein can be at least partially elastically deformable so as to be able to compensate any radial offset when joining and to be able to facilitate the joining procedure.

Furthermore, a captive protection for the receptacle element 112 and/or the fixing element 122 can be provided by means of fastening elements 160, so that a secure and reliable fastening can be ensured within the first and/or the second module 210; 220 before, during and after joining the heating device 100.

### LIST OF REFERENCE SIGNS

100 Heating device
110 First assembly
112 Receptacle element
114 First line component
116 Orientation element
120 Second assembly
122 Fixing element
124 Second line component
130 Chamfer portion
140 Chamfer portion
150 Sealing element
160 Fastening element
200 Air treatment unit
210 First module
220 Second module

1.-15. (Canceled)

16. A heating device for an air treatment unit, comprising:
a first assembly and a second assembly,
wherein the first assembly has at least one receptacle element, and the second assembly has at least one fixing element,
wherein the at least one receptacle element and the at least one fixing element are designed to engage in one another so as to at least temporarily connect the first assembly and the second assembly to one another,
wherein the receptacle element and/or the fixing element are/is designed such that the receptacle element and the fixing element are connectable in a predefined alignment range relative to one another.

17. The heating module as claimed in claim 16,
wherein the predefined alignment range is a predefined angular range.

18. The heating module as claimed in claim 16, wherein
the receptacle element and/or the fixing element are/is configured to be least partially elastically deformable.

19. The heating module as claimed in claim 16, wherein
the fixing element and/or the receptacle element have/has a chamfer portion, so that preliminary positioning of the receptacle element and the fixing element relative to one another is able to be provided before a mutual engagement is formed by the receptacle element and the fixing element for connecting the first and the second assembly.

20. The heating module as claimed in claim 19, wherein
the preliminary positioning of the receptacle element and the fixing element enables a mutual radial displacement to be compensated.

21. The heating module as claimed in claim 19, wherein
the first assembly is designed having at least one first line component, and the second assembly is designed having at least one second line component, for forming an electrical connection,
wherein an electrical contact between the first and the second assembly is establishable once the preliminary positioning of the first assembly and the second assembly relative to one another has been at least substantially performed.

22. The heating module as claimed in claim 21, wherein
at least the first line component and the second line component are designed to form a mutual plug connection.

23. The heating module as claimed in claim 22, wherein
the first and/or the second line component have/has a chamfer portion so that a radial offset between the first and the second line component is able to be compensated.

24. The heating module as claimed in claim 22, wherein
the first and/or the second line component are/is at least partially flexibly deformable, so that a radial offset between the first and the second line component is compensable.

25. The heating module as claimed in claim 16, wherein
the first assembly and/or the second assembly have/has at least one seal for sealing in a liquid-tight manner the at least temporary connection between the first assembly and the second assembly.

26. The heating module as claimed in claim 25, wherein
the first assembly and/or the second assembly are/is designed such that the at least one seal is able to be captively positioned on the first assembly and/or the second assembly.

27. The heating module as claimed in claim 25, wherein
at least one of the first and the second assembly has a fastening element for captively disposing the first and/or the second assembly in an air treatment unit.

28. The heating module as claimed in claim 27, wherein
the fastening element captively disposes the first and/or the second assembly on a first module and/or a second module of the air treatment unit, in an assembled state of the air treatment unit.

29. An air treatment unit comprising a heating device as claimed in claim 16.

30. The air treatment unit as claimed in claim 29, wherein
the air treatment unit is provided with at least one first module and at least one second module,
the first module has the first assembly of the heating device, and the second module has the second assembly of the heating device.

31. The air treatment unit as claimed in claim 30, wherein
the first module is an air dryer module or a core module of the air treatment unit, and
the second module is a core module or an air dryer module of the air treatment unit.

32. The air treatment unit as claimed in claim 29, wherein
the heating device is provided so as to be integrated into the air treatment unit in an assembled state of the heating device.
